(19) United States
(12) Patent Application Publication
(10) Pub. No.: US 2021/0108573 A1
(43) Pub. Date: Apr. 15, 2021

(54) GAS TURBINE ENGINE BOOSTER CONFIGURATION AND METHODS OF OPERATION

(71) Applicant: General Electric Company, Schenectardy, NY (US)

(72) Inventors: Arthur William Sibbach, Boxford, MA (US); Brandon Wayne Miller, Liberty Township, OH (US); Justin Paul Smith, Montgomery, OH (US); Brian Lewis Devendorf, Georgetown, MA (US); Carlos Walberto Perez, West Chester, OH (US)

(21) Appl. No.: 16/811,384

(22) Filed: Mar. 6, 2020

Related U.S. Application Data
(60) Provisional application No. 62/915,345, filed on Oct. 15, 2019.

(51) Int. Cl. F02C 9/16

(52) U.S. Cl. CPC F02C 9/16; F05D 2270/02

(57) ABSTRACT

A gas turbine engine includes a gas turbine engine core having a high pressure compressor, a combustor, and a high pressure turbine in serial relationship; and a low pressure compressor upstream of the gas turbine engine core; wherein the low pressure compressor driven by a variable speed power source such that the rotational speed of the low pressure compressor is controllable independently from the rotational speed of any turbine of the gas turbine engine.

### CROSS-REFERENCE TO RELATED APPLICATION

This application claims priority to provisional application Ser. No. 62/915,345, filed Oct. 15, 2019, which is incorporated herein by reference in its entirety.

### BACKGROUND OF THE INVENTION

The technology described herein relates to gas turbine engines, and particularly to low pressure “booster” compressors for such engines. The technology is of particular benefit when applied to gas turbine engines for aircraft propulsion.

Gas turbine engines enjoy widespread use as propulsion sources for fixed wing aircraft and rotorcraft, as well as power sources for land and marine applications. A turbofan engine operates on the principle that a central gas turbine core drives a bypass fan, the fan being located at a radial location between a nacelle of the engine and the engine core such that the fan operates within a “duct” formed by the inner surface of the nacelle but air driven by the fan “bypasses” the central gas turbine core. An open rotor propulsion system instead operates on the principle of having the bypass fan located outside of the engine nacelle, in other words, “unducted”. This permits the use of larger fan blades able to act upon a larger volume of air than for a turbofan engine, and thereby improves propulsive efficiency over conventional ducted engine designs. Turboshaft engines have a central gas turbine core, much like a turbofan engine, but instead of driving a fan the output of a turboshaft engine supplies shaft torque to another device such as a gearbox, transmission, generator, pump, or other device.

In addition to the typical elements of a gas turbine engine core, namely a high pressure (HP) compressor, a combustor, and a high pressure (HP) turbine, in serial relationship, many gas turbine engines also include a low pressure “booster” compressor upstream of the HP compressor which aids in providing a source of pre-compressed air to increase overall efficiency and power output. Booster compressors are typically driven through a shaft which is in turn driven by the HP turbine, a low pressure (LP) turbine, or an intermediate (IP) turbine, either directly or indirectly through a gearbox or transmission.

The booster compressors in such configurations are driven at a fixed rotational speed relative to one of the turbines, yet in operation gas turbine engines may be operated at varied power settings, flight speeds, altitudes, temperatures, and other conditions. Thermal efficiency, and in turn fuel consumption, may be less than optimal under certain operating conditions.

It would be desirable to provide a gas turbine engine having a low pressure “booster” compressor which may be configured and operated to deliver improved overall operational efficiency of the gas turbine engine.

### BRIEF DESCRIPTION OF THE INVENTION

A gas turbine engine includes a gas turbine engine core having a high pressure compressor, a combustor, and a high pressure turbine in serial relationship; and a low pressure compressor upstream of the gas turbine engine core; wherein the low pressure compressor driven by a variable speed power source such that the rotational speed of the low pressure compressor is controllable independently from the rotational speed of any turbine of the gas turbine engine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a cross-sectional schematic illustration of an exemplary embodiment of a gas turbine engine, for example, a turbofan or open rotor gas turbine engine for an aircraft;

FIG. 2 is a cross-sectional schematic illustration of an alternative embodiment of FIG. 1 incorporating a gearbox for transmitting power from a LP turbine to a fan;

FIG. 3 is a cross-sectional schematic illustration of an exemplary embodiment of a gas turbine engine having a power take-off shaft for use in, for example, a turboshaft, or turboprop, or more generally to serve as an input shaft of a gearbox, or electrical generator used in aviation, marine, or land-based power generation or propulsion applications;

FIG. 4 is a cross-sectional schematic illustration of an alternative embodiment of FIG. 1 incorporating a separate motor and energy storage device for running the motor configured to drive a booster;

FIG. 5 is a cross-sectional schematic illustration of an exemplary embodiment of a gas turbine engine including a generator and electric motor driven propulsors;

FIG. 6 is a cross-sectional schematic illustration of an alternative embodiment of FIG. 5 where a mechanically driven fan is replaced by an electrically driven fan;

FIG. 7 is a cross-sectional schematic illustration of an alternative embodiment of FIGS. 5 and 6, but includes a gear box;

FIG. 8 is a cross-sectional schematic illustration of an alternative embodiment of FIG. 1 incorporating a power split/power sharing device; and

FIG. 9 is a cross-sectional schematic illustration of an exemplary embodiment of a gas turbine engine.

Corresponding reference characters indicate corresponding parts throughout the several views. The exemplifications set out herein illustrate exemplary embodiments of the disclosure, and such exemplifications are not to be construed as limiting the scope of the disclosure in any manner.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 2, 5, 10, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

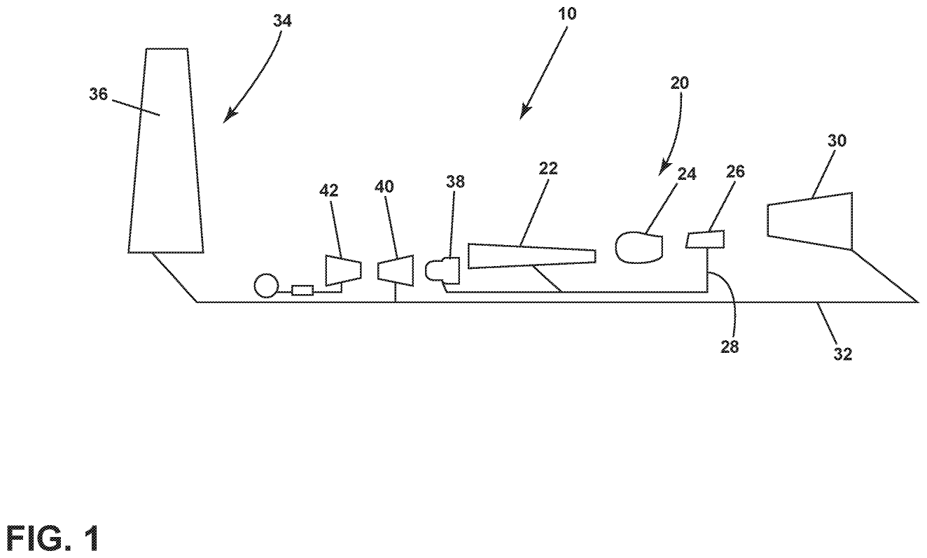

FIG. 1 shows an elevational cross-sectional view of an exemplary embodiment of a gas turbine engine 10. As is seen from FIG. 1, the gas turbine engine 10 has a core 20 which includes a high pressure (HP) compressor 22, a combustor 24, and a high pressure (HP) turbine 26, in serial relationship. The HP turbine 26 drives the HP compressor 22 through a high pressure (HP) shaft 28. A low pressure (LP) turbine 30 drives a fan assembly 34, having a plurality of fan blades 36, through a low pressure (LP) shaft 32.

In the configuration of FIG. 1, gas turbine engine 10 further includes an HP motor/generator 38, an LP motor generator 40, and a low pressure “booster” compressor 42. The booster 42 is driven rotationally by a power transfer medium which operates the booster 42 at variable speeds depending upon the operating conditions encountered in various phases of operation. The transfer medium may be a traction drive, hydraulics/pneumatics, a variable epicyclic transmission, or by electrical power transfer. The booster 42 is therefore not tied to a fixed speed ratio relative to either the HP or LP shafts, so that the booster 42 is capable of rotating at any rotational speed desired which may be faster or slower than either the HP or LP shafts.

Motor/generators 38 and 40 are electrical machines which may be either driving or driven members depending on which direction power in the system is flowing.

The booster 42 may include inlet guide vanes (IGVs), outlet guide vanes (OGVs), and variable stator vanes (VSVs).

In operation, the LP turbine may drive the booster at a lower speed during high power operations, while the booster may be operated at higher speed (overdrive) and operating line during cruise operation. At low power operations such as descent, the LP turbine may drive the core. A variable speed booster 42 can be overdriven such that the cruise overall operating pressure ratio (OPR) can be higher than the takeoff/top of climb OPR, thus significantly improving the thermal efficiency of the architecture and providing a new variable cycle engine feature. Multiple drive mechanisms are possible.

A booster 42, as operated and described herein, may utilize a variable downstream door or nozzle to facilitate a higher OPR/low physical flow operation at cruise. Optionally, the booster 42 may exhaust to a third stream in a three stream engine configuration, and optionally could back drive the core during descent idle. At cruise, for example, OPRs of 80 or greater may be achievable.

Improved fuel burn at cruise and during descent may be achievable, and reductions in engine size and/or weight may be possible. Other improvements, such as improved work split between the HP compressor and booster, and/or reductions in complexity, such as by reducing the number of or eliminating Variable Stator Vanes (VSVs), may also be possible. The LP shaft power transmitted to the booster 42 may enable beneficial power trading from LP to HP shafts during descent idle/ground idle through hydraulic, electrical, traction drive, pneumatic ADM, closed loop CO2 fluidic power transfer, torque converter/fluidic couplings, and/or mechanical/electrical variable drive systems.

An optional reversing gearbox may be included to permit a common gas generator and low pressure turbine to be used to rotate the fan blades either clockwise or counterclockwise, i.e., to provide either left- or right-handed configurations, as desired, such as to provide a pair of oppositely-rotating engine assemblies as may be desired for certain aircraft installations. An optional power gearbox may include a gearset for decreasing the rotational speed of the fan assembly relative to the low pressure turbine 30.

FIG. 1 illustrates what may be termed a “puller” configuration where the fan assembly 34 is located forward of the core gas turbine 20. Other configurations are possible and contemplated as within the scope of the present disclosure, such as what may be termed a “pusher” configuration embodiment where the core gas turbine 20 is located forward of the fan assembly 34. A variety of architectures are shown and described in commonly-assigned US patent application publication US 2015/0291276A1, which is incorporated herein by reference.

The selection of “puller” or “pusher” configurations may be made in concert with the selection of mounting orientations with respect to the airframe of the intended aircraft application, and some may be structurally or operationally advantageous depending upon whether the mounting location and orientation are wing-mounted, fuselage-mounted, or tail-mounted configurations.

In addition to configurations suited for use with a conventional aircraft platform intended for horizontal flight, the technology described herein could also be employed for helicopter and tilt rotor applications and other lifting devices, as well as hovering devices.

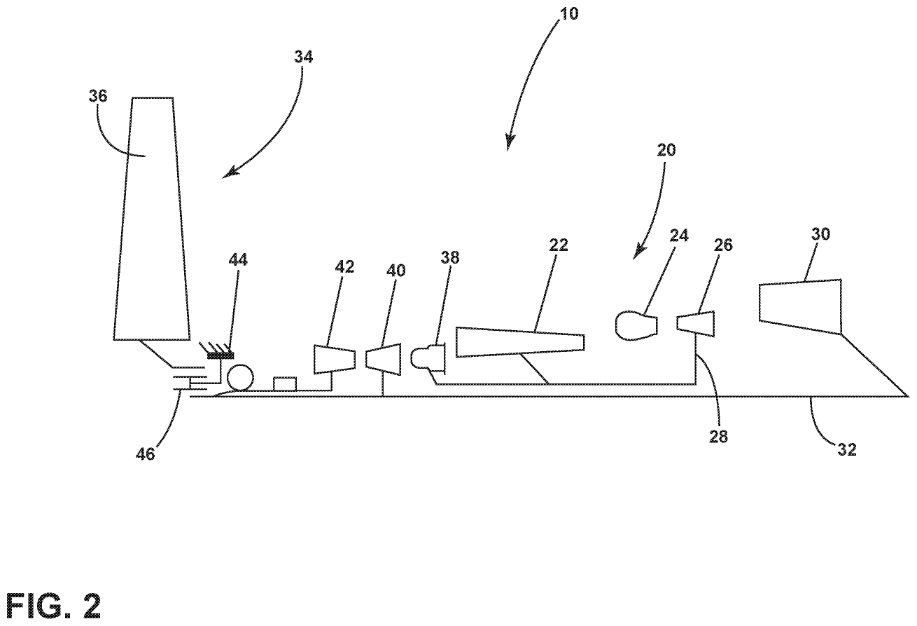

FIG. 2 illustrates schematically a cross-sectional illustration of a gas turbine engine 10 similar in many respects to the gas turbine engine 10 of FIG. 1, and like numerals are utilized to refer to like elements such as, for example, variable speed booster 42. In the embodiment of FIG. 2, the gas turbine engine 10 is a geared turbofan engine suitable for use as a propulsion system for aircraft. An epicyclic gear box 46 (which is schematically illustrated as being fixed to a stationary or non-rotating frame of the engine) reduces the rotational speed of the fan assembly 34 relative to the LP turbine 30, allowing both the fan assembly 34 and the LP turbine 30 to optimize their respective efficiencies. The epicyclic gear box 46 may be a star gear box, where the planet carrier is fixed to the stationary support, or a planetary gear box, where the ring gear is fixed and the fan shaft is connected to the planet carrier. Other epicyclic or non-epicyclic gear box configurations may also be utilized. The fan and LP turbine may either co- or counter-rotate depending on the gear box configuration utilized. Representative gear box ratios of greater than 1.5:1, such as in the range of 1.5-5.0:1, and greater than 2.3:1, such as in the range of 2.3-5.0:1, may be utilized. By reducing the rotational speed of the fan assembly 34 relative to the LP turbine 30, tip speeds of the fan blades 36 may be reduced below 1400 feet per second (fps). Bypass ratios (BPRs) of greater than 6.0, and greater than 8.0, have been contemplated, as have BPRs of greater than 11.0 such as in the range of 11.0-22.0. Fan pressure ratios (FPRs) of less than 1.7, and less than 1.48, have been contemplated as well.

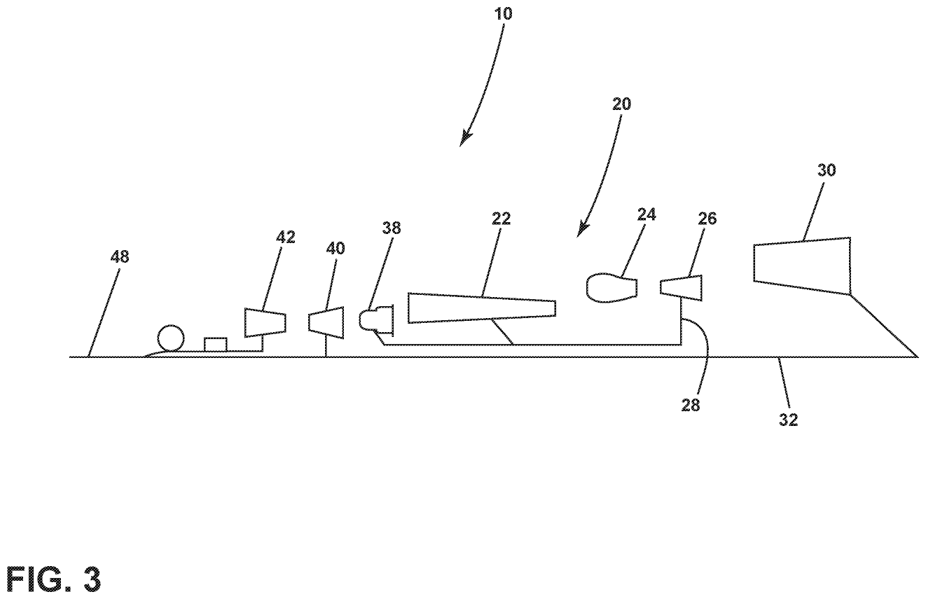

FIG. 3 illustrates schematically a cross-sectional illustration of a gas turbine engine 10 similar in many respects to the gas turbine engine 10 of FIG. 1, and like numerals are utilized to refer to like elements such as, for example, variable speed booster 42. In the embodiment of FIG. 3, the gas turbine engine 10 is a turboshaft engine suitable for use in powering a propeller or rotor assembly, or a gearbox or electrical generator for aviation, marine, or land-based power generation or propulsion applications. Gas turbine engine 10 therefore includes a power take-off shaft 48 suitable for powering such equipment.

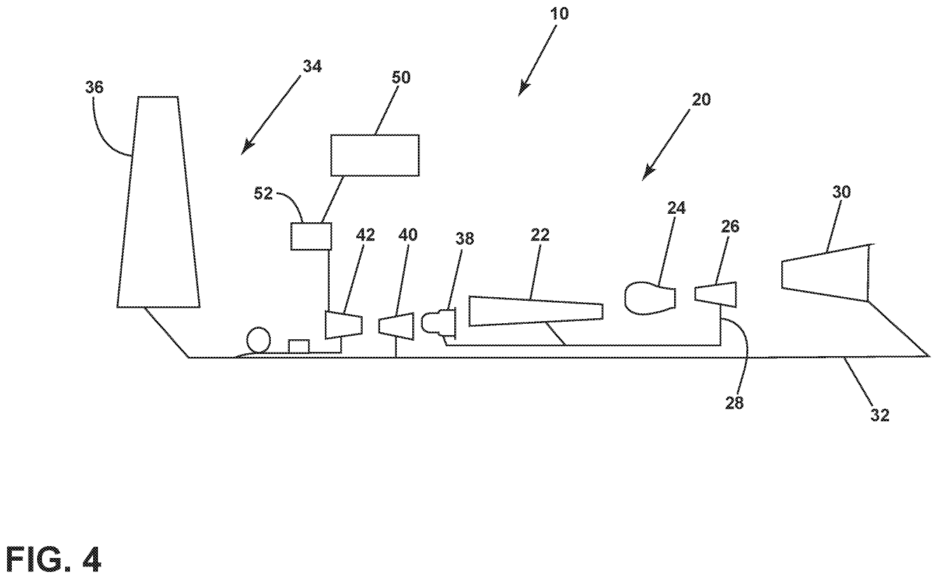

FIG. 4 illustrates schematically a cross-sectional illustration of a gas turbine engine 10 similar in many respects to the gas turbine engine 10 of FIG. 1, and like numerals are utilized to refer to like elements such as, for example, variable speed booster 42. In the embodiment of FIG. 4, the gas turbine engine 10 is capable of additional operating modes. The engine 10 may include an energy storage device 50 which can be used to power the variable speed booster 42 independently of the operation of the gas turbine engine 10 via an electric motor 52. For example, the energy storage device 50, such as a battery, capacitor, or supercapacitor, can drive the booster 42 during single engine taxi operations or another form of power source such as aircraft power (auxiliary power unit (APU)) or ground power (power cart, etc.) can be utilized to drive the booster 42 during engine shutdown. This can aid in cooling the interior components of the gas turbine engine 10 during shutdown to minimize distortion effects often referred to as rotor bow. In such a configuration, the booster 42 provides air to the core 20 while not rotationally driving the core 20 directly. Variable stator vanes, if any, can be positioned to provide maximum potential airflow during shutdown conditions. The electric motor 52 is not connected to the accessory gearbox associated with either the LP shaft 32 or HP shaft 28, but instead is dedicated to drive only the booster 42. The energy storage device 50 may be charged during engine operation to power the booster motor 52 during shutdown periods. The energy storage device 50 can be included in a health monitoring system, to report the life remaining of the energy storage device either with a direct indicator (light, etc.) or a message to the aircraft via a Full Authority Digital Engine Control (FADEC).

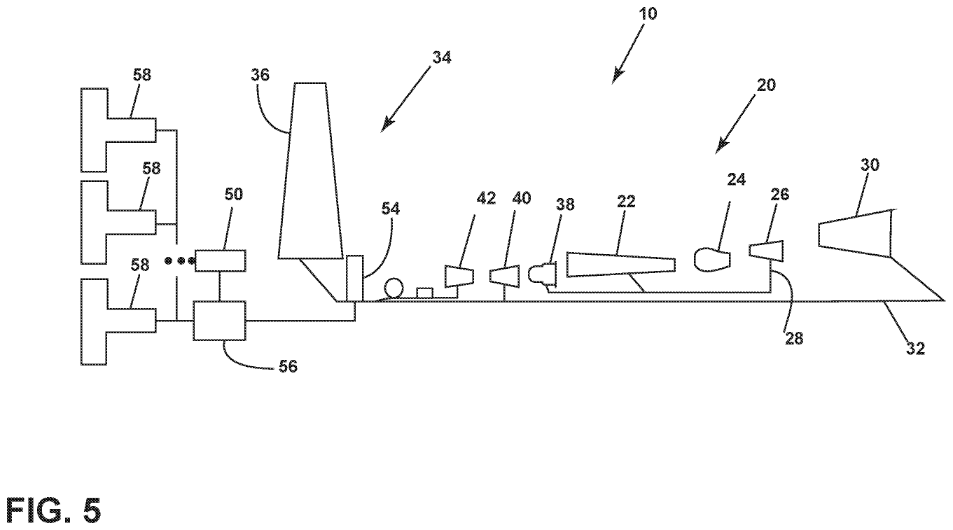

FIGS. 5-7 illustrate schematically cross-sectional illustrations of a gas turbine engine 10 similar in many respects to the gas turbine engine 10 of FIG. 1, and like numerals are utilized to refer to like elements such as, for example, variable speed booster 42. In the embodiments of FIGS. 5-7, the gas turbine engine 10 forms part of a hybrid-electric propulsion system.

In the embodiment of FIG. 5, the gas turbine engine 10 includes a mechanically driven fan assembly 34 driven by the LP turbine 30, as described previously, as well as a motor/generator 54, which includes an optional clutch to disengage the motor/generator 54 from the gas turbine engine 10. The motor/generator 54 provides power through a power conditioning and distribution system 56 to power one or more electric motor driven propulsors 58 which may be located remotely from the gas turbine engine 10. Optional energy storage device 50 may be incorporated into the system to provide power to the propulsors 58. The motor/generator 54 may be coaxially mounted on the LP shaft 32, which powers the fan assembly 34. The electrically driven propulsors 58 may be stand alone fans with electric motors, or may include a turbine engine, such that the fans of both (or all) engines could be driven with only a single turbine engine operating.

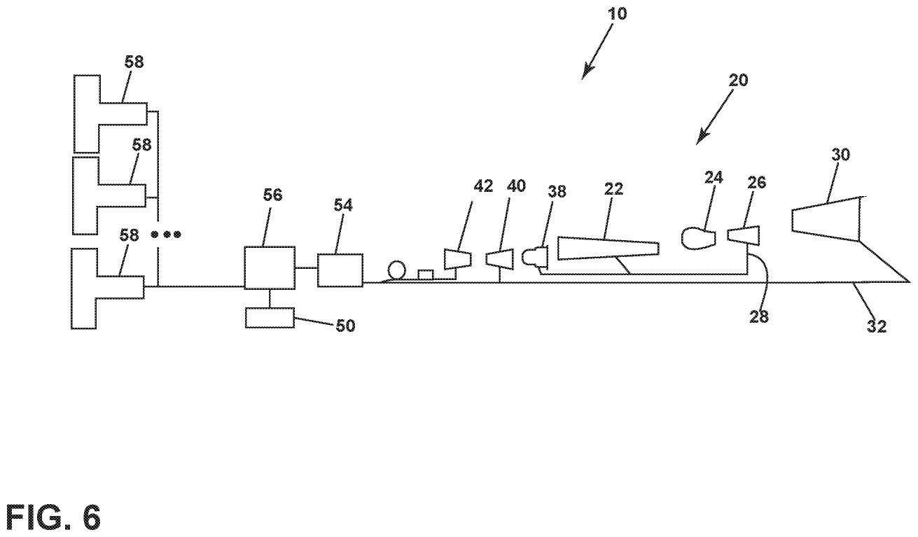

The embodiment of FIG. 6 is similar to that of FIG. 5, but omits the mechanically driven fan 34 in favour of a purely-electrical propulsion system powered by the generator or motor/generator 54. The optional energy storage device 50 may provide power for starting the gas turbine engine, may provide a boost of power to improve engine operability, may provide propulsive power with the gas turbine engine 10 shut down, and may provide power to rotate the gas turbine engine 10 during shutdown, to mitigate rotor bow as discussed previously.

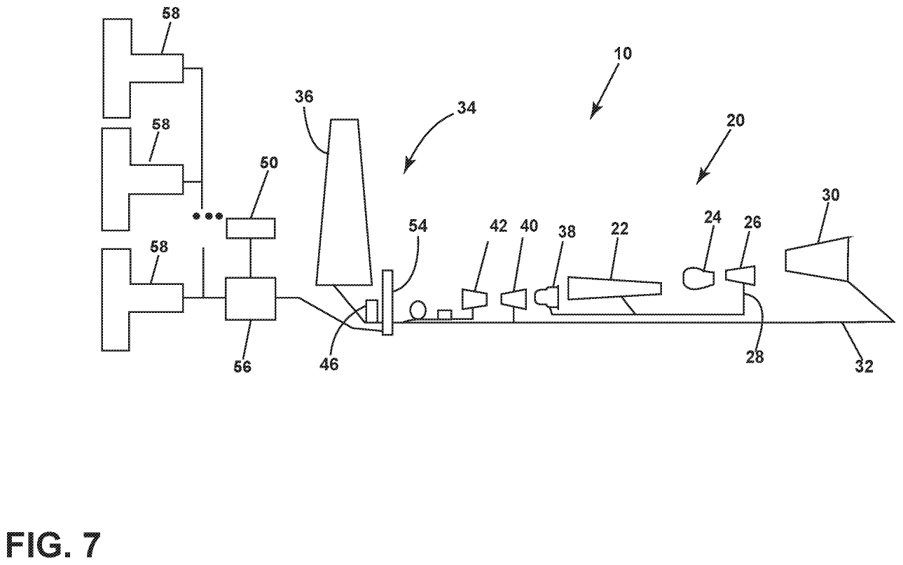

The embodiment of FIG. 7 is also similar to that of FIGS. 5 and 6, but includes a reducing gear box 46 for reducing the speed of the fan assembly 34 relative to the LP turbine 30, as described previously with respect to FIG. 2. The gear box can be located either forward or aft of the motor/generator 54, depending on the desired optimum speed for the motor/generator.

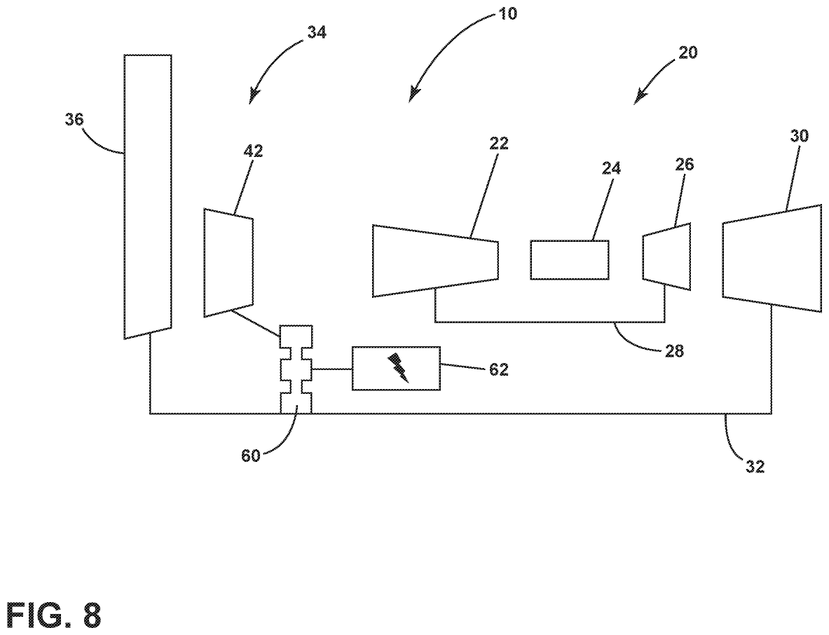

FIG. 8 illustrates schematically a cross-sectional illustration of a gas turbine engine 10 similar in many respects to the gas turbine engine 10 of FIG. 1, and like numerals are utilized to refer to like elements such as, for example, variable speed booster 42. In the embodiment of FIG. 8, the gas turbine engine 10 includes a power sharing/power split device 60. In such a configuration, power may be provided by either or both of two power sources depending upon the operating conditions and power demand. In the embodiment of FIG. 8, power to the variable speed booster 42 may be provided by the LP shaft 32, by the electric motor/generator 62, or both, as needed for the desired operating conditions. In such a configuration, some or all power may be provided mechanically, and then electrical or other power can be supplied in parallel with the mechanical power source in parallel to allow a change in the speed of the variable speed booster relative to the LP shaft 32.

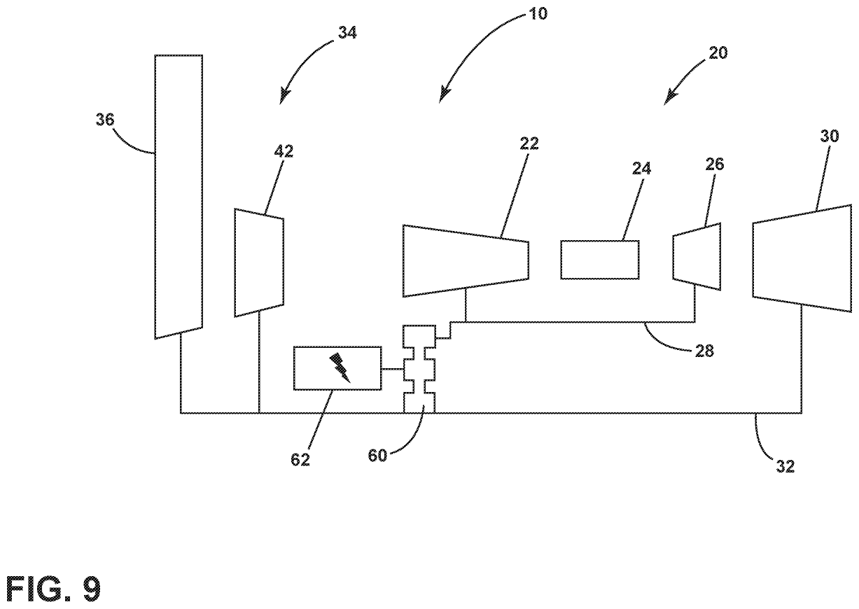

FIG. 9 illustrates schematically a cross-sectional illustration of a gas turbine engine 10 similar in many respects to the gas turbine engine 10 of FIG. 1, and like numerals are utilized to refer to like elements such as, for example, variable speed booster 42. In the embodiment of FIG. 9, similar to FIG. 8, the gas turbine engine 10 includes a power sharing/power split device 60 which is similar in function to those utilized in many hybrid automobiles today. In such a configuration, power may be provided by either or both of two power sources depending upon the operating conditions and power demand. In the embodiment of FIG. 9, the power sharing/power split device 60 is incorporated between and governs power sharing between the LP shaft 32 and HP shaft 28, and the variable speed booster 42 is coupled to the LP shaft along with the fan assembly 34. Power injection/subtraction via the power sharing device 60 thus changes the way power flows in relative terms between the LP shaft 32 and HP shaft 34.

FIGS. 8 and 9 thus illustrate that a power sharing/power split device 60 can be utilized to incorporate or blend power inputs from 2 mechanical sources or 1 mechanical source and 1 electrical source, and other combinations of power sharing and power transfer may be achieved as well. Such devices may be utilized in any of the embodiments depicted herein to serve as a speed variation device for the variable speed booster 42. Such devices may be gear type, traction drive, CO2 driven, or any suitable mechanism and could be single or 2-stage, and could incorporate compound planets, face gears, or any number of potential configurations.

Various characteristics, aspects, and advantages of the present disclosure may also be embodied in any permutation of aspects of the disclosure, including but not limited to the following technical solutions as defined in the enumerated aspects:

1. A gas turbine engine includes a gas turbine engine core having a high pressure compressor, a combustor, and a high pressure turbine in serial relationship; and a low pressure compressor upstream of the gas turbine engine core; wherein the low pressure compressor driven by a variable speed power source such that the rotational speed of the low pressure compressor is controllable independently from the rotational speed of any turbine of the gas turbine engine.

2. The gas turbine engine of Aspect 1, wherein the gas turbine engine includes a fan assembly.

3. The gas turbine engine of Aspect 2, wherein the fan assembly is driven through a gear box.

4. The gas turbine engine of Aspect 3, wherein the gear box is a reversing gearbox to permit the fan to rotate in a direction opposite to the low pressure turbine.

5. The gas turbine engine of Aspect 3, wherein the gear box has a ratio of 1.5-5.0:1 or 2.3-5.0:1.

6. The gas turbine engine of Aspect 2, wherein the bypass ratio (BPR) is 11.0-22.0.

7. The gas turbine engine of Claim 2, wherein the fan pressure ratio (FPR) is less than 1.7.

8. The gas turbine engine of Aspects 1-7, wherein the low pressure compressor is electrically driven.

9. The gas turbine engine of Aspect 8, wherein the source of electrical power for the low pressure compressor is the low pressure turbine, the high pressure turbine, or a combination thereof.

10. The gas turbine engine of Aspect 8, wherein the source of electrical power is external to the engine, such as an auxiliary power unit, ground power unit, power storage device, cross engine drive, or a combination thereof.

11. The gas turbine engine of Aspects 1-10, wherein the gas turbine engine forms a portion of a hybrid-electric propulsion system.

12. The gas turbine engine of Aspect 11, wherein the hybrid-electric propulsion system includes one or more electric motor driven propulsors.

13. The gas turbine engine of Aspects 1-12, wherein an energy storage device provides electrical power to the low pressure compressor.

14. The gas turbine engine of Aspects 1-13, wherein the low pressure compressor is driven through a mechanical power transfer medium such as a traction drive, hydraulic drive, pneumatic drive, a variable epicyclic transmission, or a combination thereof

15. The gas turbine engine of Aspect 14, wherein the source of power for the low pressure compressor is a low pressure turbine, the high pressure turbine, or a combination thereof.

16. The gas turbine engine of Aspects 1-15, wherein the gas turbine engine includes a power take-off shaft.

17. The gas turbine engine of Aspects 1-16, wherein the low pressure compressor includes one or more inlet guide vanes (IGVs), outlet guide vanes (OGVs), or variable stator vanes (VSVs).

18. The gas turbine engine of Aspects 1-17, wherein the low pressure compressor is operable when the gas turbine engine is shut down.

19. The gas turbine engine of Aspects 1-18, wherein the low pressure compressor is capable of rotating faster or slower than any turbine of the gas turbine engine.

20. The gas turbine engine of Aspects 1-19, wherein the low pressure compressor is driven by a power sharing/power split device providing power from either or both of two power sources.

21. A method of operating a gas turbine engine, the gas turbine engine including a gas turbine engine core having a high pressure compressor, a combustor, and a high pressure turbine in serial relationship; and a low pressure compressor upstream of the gas turbine engine core; comprising the step of: driving the low pressure compressor by a variable speed power source such that the rotational speed of the low pressure compressor is controllable independently from the rotational speed of any turbine of the gas turbine engine.

22. The method of Aspect 21, further comprising operating the low pressure compressor when the gas turbine engine is shut down.

23. The method of Aspects 21-22, further comprising rotating the low pressure compressor faster or slower than any turbine of the gas turbine engine.

24. The method of Aspects 21-23, further comprising driving the low pressure compressor by a power sharing/power split device providing power from either or both of two sources.

25. The method of Aspects 21-24, further comprising driving the low pressure compressor at a lower speed during high power operation.

While this disclosure has been described as having exemplary embodiments, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A gas turbine engine comprising;
a gas turbine engine core having a high pressure compressor, a combustor, and a high pressure turbine in serial relationship; and
a low pressure compressor upstream of the gas turbine engine core;
wherein the low pressure compressor driven by a variable speed power source such that the rotational speed of the low pressure compressor is controllable independently from the rotational speed of any turbine of the gas turbine engine.

2. The gas turbine engine of claim 1, wherein the gas turbine engine includes a fan assembly.

3. The gas turbine engine of claim 2, wherein the fan assembly is driven through a gear box.

4. The gas turbine engine of claim 3, wherein the gear box is a reversing gearbox to permit the fan to rotate in a direction opposite to the low pressure turbine.

5. The gas turbine engine of claim 3, wherein the gear box has a ratio of 1.5-5.0:1 or 2.3-5.0:1.

6. The gas turbine engine of claim 2, wherein the bypass ratio (BPR) is 11.0-22.0.

2. turbine engine of claim 2, wherein the fan pressure ratio (FPR) is less than 1.7.

8. The gas turbine engine of claim 1, wherein the low pressure compressor is electrically driven.

9. The gas turbine engine of claim 8, wherein the source of electrical power for the low pressure compressor is the low pressure turbine, the high pressure turbine, or a combination thereof.

10. The gas turbine engine of claim 8, wherein the source of electrical power is external to the engine, such as an auxiliary power unit, ground power unit, power storage device, cross engine drive, or a combination thereof.

11. The gas turbine engine of claim 1, wherein the gas turbine engine forms a portion of a hybrid-electric propulsion system.

12. The gas turbine engine of claim 11, wherein the hybrid-electric propulsion system includes one or more electric motor driven propulsors.

13. The gas turbine engine of claim 1, wherein an energy storage device provides electrical power to the low pressure compressor.

14. The gas turbine engine of claim 1, wherein the low pressure compressor is driven through a mechanical power transfer medium such as a traction drive, hydraulic drive, pneumatic drive, a variable epicyclic transmission, or a combination thereof.

15. The gas turbine engine of claim 14, wherein the source of power for the low pressure compressor is a low pressure turbine, the high pressure turbine, or a combination thereof.

16. The gas turbine engine of claim 1, wherein the gas turbine engine includes a power take-off shaft.

17. The gas turbine engine of claim 1, wherein the low pressure compressor includes one or more inlet guide vanes (IGVs), outlet guide vanes (OGVs), or variable stator vanes (VSVs).

18. The gas turbine engine of claim 1, wherein the low pressure compressor is operable when the gas turbine engine is shut down.

19. The gas turbine engine of claim 1, wherein the low pressure compressor is capable of rotating faster or slower than any turbine of the gas turbine engine.

20. The gas turbine engine of claim 1, wherein the low pressure compressor is driven by a power sharing/power split device providing power from either or both of two power sources.
